(19) United States
(12) Patent Application Publication
(10) Pub. No.: US 2025/0390881 A1
(43) Pub. Date: Dec. 25, 2025

(54) METHOD AND SYSTEM FOR REAL-TIME SCAM DETECTION USING MACHINE LEARNING TECHNIQUES

(71) Applicant: JPMorgan Chase Bank, N.A., New York, NY (US)

(72) Inventors: Sachin KUMAR, Plano, TX (US); Imran U. AHMAD, Bengaluru (IN); Ajay K. CHATURVEDI, Hyderabad (IN); Vikas GUPTA, Delaware, OH (US)

(73) Assignee: JPMorgan Chase Bank, N.A., New York, NY (US)

(21) Appl. No.: 19/222,381

(22) Filed: May 29, 2025

(30) Foreign Application Priority Data
Jun. 21, 2024 (IN) 202411047781

(51) Int. Cl. G06Q 20/40

(52) U.S. Cl. CPC G06Q 20/4016; G06Q 20/4014

(57) ABSTRACT

A method and a system for performing real-time fraud detection by proactively identifying fraudulent activity before executing a transaction are provided. The method includes: receiving, from a user, first information that relates to a proposed transaction; providing the first information as an input to a machine learning model; using the machine learning model to generate an output that relates to potentially fraudulent activity associated with the first information; generating, based on the first output, an alert message that includes second information that relates to notifying the user about the potentially fraudulent activity; and transmitting the alert message to the user. The output may include a score that relates to a likelihood that the first information is associated with actual fraudulent activity, and the score may be normalized to fall in a range of between zero and ten.

### CROSS-REFERENCE TO RELATED APPLICATIONS

This application claims priority from Indian Patent Application No. 202411047781, filed in the India Patent Office on Jun. 21, 2024, which is hereby incorporated by reference in its entirety.

### BACKGROUND

### 1. Field of the Disclosure

This technology generally relates to methods and systems for fraud detection, and more particularly to methods and systems for performing real-time fraud detection by using machine learning techniques to proactively identify fraudulent activity before transaction execution is completed.

### 2. Background Information

In the modern digital landscape, the necessity for real-time payments has become paramount for consumers and businesses worldwide. However, the rapid nature of such transactions increases the risk of irreversible payments, and malicious actors seek to exploit this risk in order to deceive unsuspecting users.

Currently, financial institutions and financial technology companies lack adequate measures to safeguard users in these situations, and as a result, there is a failure to provide timely warnings about potential scams during the payment process. Accordingly, there is a need for a mechanism for performing real-time fraud detection by using machine learning techniques to proactively identify fraudulent activity before transaction execution is completed.

### SUMMARY

The present disclosure, through one or more of its various aspects, embodiments, and/or specific features or sub-components, provides, inter alia, various systems, servers, devices, methods, media, programs, and platforms for performing real-time fraud detection by using machine learning techniques to proactively identify fraudulent activity before transaction execution is completed.

According to an aspect of the present disclosure, a method for performing real-time fraud detection by proactively identifying fraudulent activity before executing a transaction is provided. The method is implemented by at least one processor. The method includes: receiving, from a user, first information that relates to a proposed transaction; providing, as an input to a first machine learning (ML) model, the first information; using the first ML model to generate a first output that relates to potentially fraudulent activity associated with the first information; generating, based on the first output, an alert message that includes second information that relates to notifying the user about the potentially fraudulent activity; and transmitting, to the user, the alert message.

The first output may include a first score that relates to a likelihood that the first information is associated with actual fraudulent activity, and wherein the score falls in a range of between zero (0) and ten (10).

The method may further include: providing, as an input to a second ML model that is a large language model (LLM), the first information and the alert message; and using the second ML model to generate a second output that includes third information that relates to educating the user about the potentially fraudulent activity.

The third information may include information that relates to at least one from among an online puppy scam, an animal sale scam, a merchandise and services scam, a fake property for sale scam, a fake investment scam, a company impersonator scam, a government agency impersonator scam, and a bank impersonator scam.

The third information may include information that relates to prompting the user to provide an input relating to a reason for sending a payment in connection with the proposed transaction.

The third information may further include a plurality of user-selectable candidate explanations for the sending of the payment.

The third information may include information that relates to prompting the user to provide an input relating to one from among proceeding with sending a payment in connection with the proposed transaction and not proceeding with sending the payment in connection with the proposed transaction.

The first information may include at least one from among a name of the user, a geographical address of the user, an email address of the user, a telephone number of the user, a proposed date for the proposed transaction, a proposed time of execution for the proposed transaction, an amount of money to be transferred in the proposed transaction, and a recipient of the money to be transferred.

The first ML model may be initially trained by using first historical information that relates to previously executed transactions and second historical information that relates to scams and fraudulent activity.

The method may further include updating a training of the first ML model by using additional information that relates to recently executed transactions that have been executed after the initial training of the ML model is completed.

According to another embodiment, a computing apparatus for performing real-time fraud detection by proactively identifying fraudulent activity before executing a transaction is provided. The computing apparatus includes a processor; a memory; and a communication interface coupled to each of the processor and the memory. The processor may be configured to: receive, from a user via the communication interface, first information that relates to a proposed transaction; provide, as an input to a first machine learning (ML) model, the first information; use the first ML model to generate a first output that relates to potentially fraudulent activity associated with the first information; generate, based on the first output, an alert message that includes second information that relates to notifying the user about the potentially fraudulent activity; and transmit, to the user via the communication interface, the alert message.

The first output may include a first score that relates to a likelihood that the first information is associated with actual fraudulent activity, and wherein the score falls in a range of between zero (0) and ten (10).

The processor may be further configured to: provide, as an input to a second ML model that is a large language model (LLM), the first information and the alert message; and use the second ML model to generate a second output that includes third information that relates to educating the user about the potentially fraudulent activity.

The third information may include information that relates to at least one from among an online puppy scam, an animal sale scam, a merchandise and services scam, a fake property for sale scam, a fake investment scam, a company impersonator scam, a government agency impersonator scam, and a bank impersonator scam.

The third information may include information that relates to prompting the user to provide an input relating to a reason for sending a payment in connection with the proposed transaction.

The third information may further include a plurality of user-selectable candidate explanations for the sending of the payment.

The third information may include information that relates to prompting the user to provide an input relating to one from among proceeding with sending a payment in connection with the proposed transaction and not proceeding with sending the payment in connection with the proposed transaction.

The first information may include at least one from among a name of the user, a geographical address of the user, an email address of the user, a telephone number of the user, a proposed date for the proposed transaction, a proposed time of execution for the proposed transaction, an amount of money to be transferred in the proposed transaction, and a recipient of the money to be transferred.

According to yet another embodiment, a non-transitory computer readable storage medium storing instructions for performing real-time fraud detection by proactively identifying fraudulent activity before executing a transaction is provided. The storage medium includes a set of executable code which, when executed by a processor, may cause the processor to: receive, from a user, first information that relates to a proposed transaction; provide, as an input to a first machine learning (ML) model, the first information; use the first ML model to generate a first output that relates to potentially fraudulent activity associated with the first information; generate, based on the first output, an alert message that includes second information that relates to notifying the user about the potentially fraudulent activity; and transmit, to the user, the alert message.

The first output may include a first score that relates to a likelihood that the first information is associated with actual fraudulent activity, and wherein the score falls in a range of between zero (0) and ten (10).

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system, according to an embodiment.

FIG. 2 illustrates a network diagram of a network environment, according to an embodiment.

FIG. 3 illustrates a system diagram of a system, according to an embodiment.

FIG. 4 illustrates a process diagram of a process for performing real-time fraud detection by using machine learning techniques to proactively identify fraudulent activity before transaction execution is completed, according to an embodiment.

FIG. 5 illustrates a flow diagram for performing real-time fraud detection by using machine learning techniques to proactively identify fraudulent activity before transaction execution is completed, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

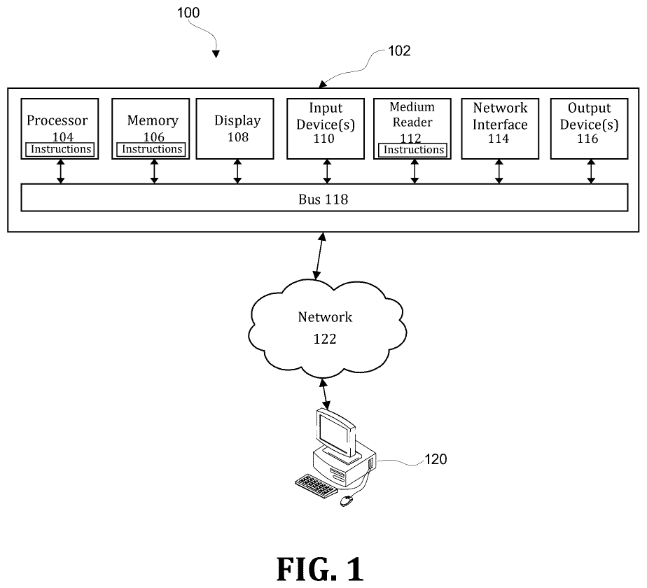

FIG. 1 illustrates a system diagram of a system 100 in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for performing real-time fraud detection by using machine learning techniques to proactively identify fraudulent activity before transaction execution is completed.

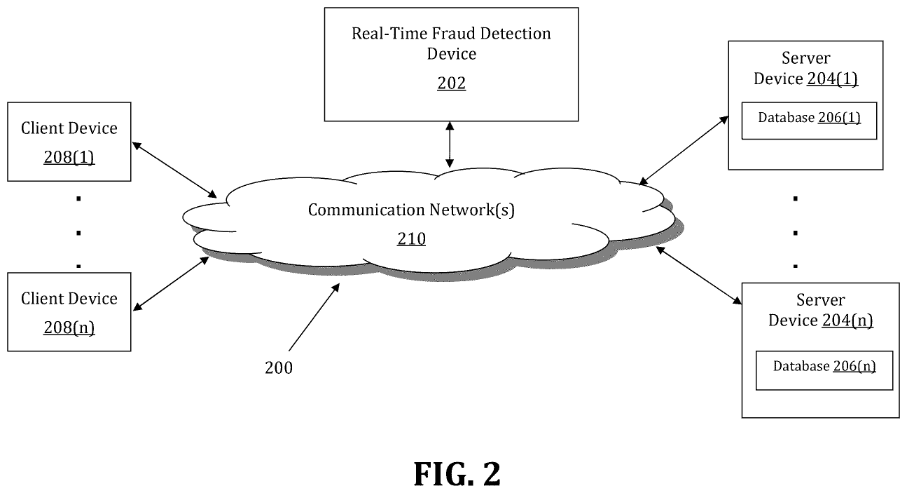

Referring to FIG. 2, a schematic of a network environment 200 for implementing a method for performing real-time fraud detection by using machine learning techniques to proactively identify fraudulent activity before transaction execution is completed is illustrated. In some embodiments, the method may be executable on any networked computer platform, such as, for example, a personal computer (PC).

The method for performing real-time fraud detection by using machine learning techniques to proactively identify fraudulent activity before transaction execution is completed may be implemented by a Real-Time Fraud Detection (RTFD) device 202. The RTFD device 202 may be the same or similar to the computer system 102 as described with respect to FIG. 1. The RTFD device 202 may store one or more applications that may include executable instructions that, when executed by the RTFD device 202, cause the RTFD device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RTFD device 202 itself, may be located in virtual server(s) running in a cloud-based computing environment rather than being tied to one or more specific physical network computing devices. Also, the application(s) may be running in one or more virtual machines (VMs) executing on the RTFD device 202. Additionally, in one or more embodiments, virtual machine(s) running on the RTFD device 202 may be managed or supervised by a hypervisor.

In the network environment 200 of FIG. 2, the RTFD device 202 may be coupled to a plurality of server devices 204(1)-204(n) that hosts a plurality of databases 206(1)-206(n), and also to a plurality of client devices 208(1)-208(n) via communication network(s) 210. A communication interface of the RTFD device 202, such as the network interface 114 of the computer system 102 of FIG. 1, may operatively couple and communicate between the RTFD device 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RTFD device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and RTFD devices that efficiently implement a method for performing real-time fraud detection by using machine learning techniques to proactively identify fraudulent activity before transaction execution is completed.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The RTFD device 202 may be a standalone device or integrated with one or more other devices or apparatuses, such as one or more of the server devices 204(1)-204(n), for example. In one particular example, the RTFD device 202 may include or be hosted by one of the server devices 204(1)-204(n), and other arrangements are also possible. Moreover, one or more of the devices of the RTFD device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the RTFD device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of information, such as historical information that relates to executed transactions and historical information that relates to frauds and scams.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the RTFD device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the RTFD device 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the RTFD device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are mere examples, as many variations of the specific hardware and software used to implement the examples are possible, as will be appreciated by those skilled in the relevant art(s).

One or more of the devices depicted in the network environment 200, such as the RTFD device 202, the server devices 204(1)-204(n), or the client devices 208(1)-208(n), for example, may be configured to operate as virtual instances on the same physical machine. In other words, one or more of the RTFD device 202, the server devices 204(1)-204(n), or the client devices 208(1)-208(n) may operate on the same physical device rather than as separate devices communicating through communication network(s) 210. Additionally, there may be more or fewer RTFD devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

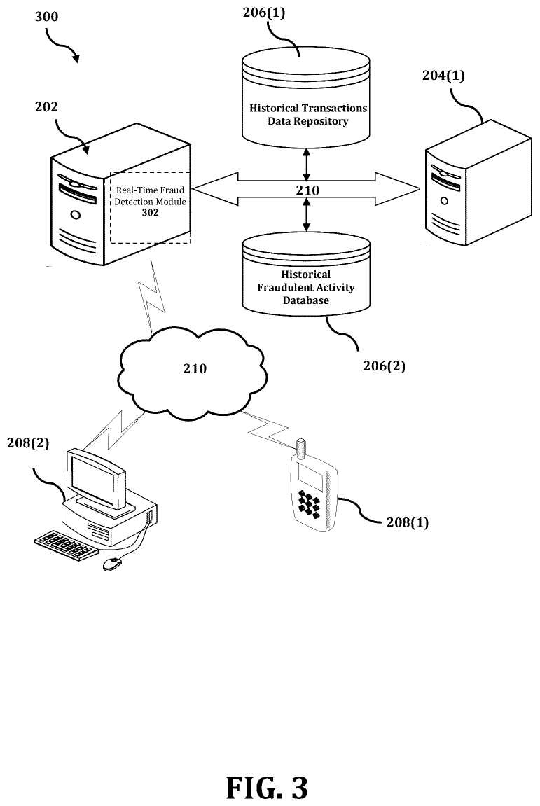

The RTFD device 202 is described and illustrated in FIG. 3 as including a real-time fraud detection (RTFD) module 302, although it may include other rules, policies, modules, databases, or applications, for example. As will be described below, the RTFD module 302 may be configured to implement a method for performing real-time fraud detection by using machine learning techniques to proactively identify fraudulent activity before transaction execution is completed.

A system 300 for implementing a mechanism for performing real-time fraud detection by using machine learning techniques to proactively identify fraudulent activity before transaction execution is completed by utilizing the network environment of FIG. 2 is illustrated in FIG. 3. Specifically, a first client device 208(1) and a second client device 208(2) are illustrated as being in communication with RTFD device 202. In this regard, the first client device 208(1) and the second client device 208(2) may be “clients” of the RTFD device 202 and are described herein as such. Nevertheless, it is to be known and understood that the first client device 208(1) and/or the second client device 208(2) need not necessarily be “clients” of the RTFD device 202, or any entity described in association therewith herein. Any additional or alternative relationship may exist between either or both of the first client device 208(1) and the second client device 208(2) and the RTFD device 202, or no relationship may exist.

Further, RTFD device 202 is illustrated as being able to access a historical transactions data repository 206(1) and a historical fraudulent activity database 206(2). The RTFD module 302 may be configured to access these databases for implementing a method for performing real-time fraud detection by using machine learning techniques to proactively identify fraudulent activity before transaction execution is completed.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the RTFD device 202 via broadband and/or cellular communication. Of course, these embodiments are not limiting or exhaustive.

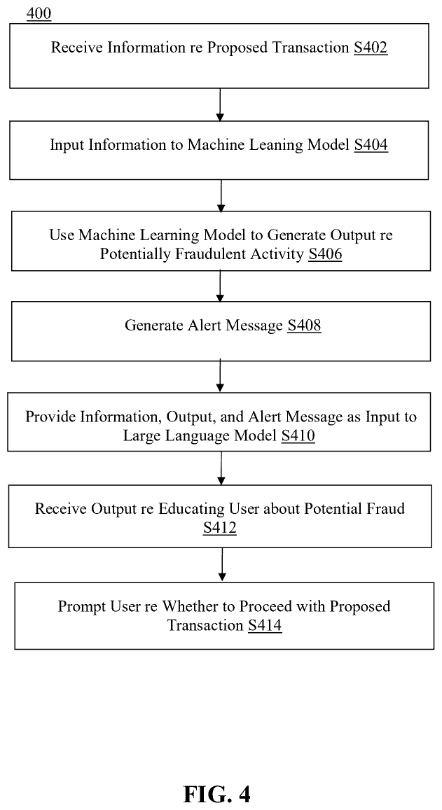

Upon being started, the RTFD module 302 may execute a process for performing real-time fraud detection by using machine learning techniques to proactively identify fraudulent activity before transaction execution is completed. Referring to FIG. 4, a process 400 for performing real-time fraud detection by using machine learning techniques to proactively identify fraudulent activity before transaction execution is completed is illustrated according to an embodiment.

In process 400 of FIG. 4, at step S402, the RTFD module 302 may receive first information that relates to a proposed transaction from a user. In an embodiment, the first information may include identifying information about the user, such as any one or more of a name, a geographical address, an email address, and/or a telephone number. In addition, the first information may include transaction-specific information, such as a proposed date and/or time for execution of the proposed transaction, an amount of money to be transferred, a recipient of the money to be transferred, and/or any other type of information that relates to the proposed transaction.

At step S404, the RTFD module 302 may provide the first information to a first artificial intelligence (AI)/machine learning (ML) model as an input thereto. Then, at step S406, the RTFD module 302, the first AI/ML model may be employed to generate an output that relates to potentially fraudulent activity that is associated with the first information. The output may include a score, such as a “fraud score” or a “scam score”, that relates to a likelihood that the first information is associated with actual fraudulent activity. The score may be normalized so that it falls within a predetermined range, such as, for example, a range of between zero (0) and ten (10), i.e., 0-10, or a range of between zero and one hundred, i.e., 0-100.

In an embodiment, the first AI/ML model may be initially trained by using historical information that relates to various transactions and historical information that relates to scams and fraudulent activity. In an embodiment, the training of the first ML model may be updated by using additional information that relates to recently executed transactions that have been executed after the initial training of the ML model is completed.

At step S408, the RTFD module 302 may generate an alert message that is based on the output of the first AI/ML model generated in step S406. The alert message may include second information that relates to notifying the user about the potentially fraudulent activity.

At step S410, the RTFD module 302 may provide the first information, the output of the first AI/ML model, and the alert message as an input to a second AI/ML model that may be a large language model (LLM) that is designed to perform generative AI tasks. Then, at step S412, the RTFD module 302 may receive, as an output from the second AI/ML model, third information that may include information that relates to educating the user about the potentially fraudulent activity and/or a warning that there is a high probability that proceeding with the proposed transaction may cause the user to incur an irreversible loss of the money to be transferred.

At step S414, the RTFD module 302 may prompt the user to provide an input relating to one from among proceeding with sending a payment in connection with the proposed transaction and not proceeding with sending the payment in connection with the proposed transaction. In an embodiment, the third information may include a user prompt that is displayable via a user interface on a screen of a user device, such as a personal computer monitor or a mobile phone, so that the user is able to simultaneously read the educational information and to observe the user prompt, which may be in the form of buttons that enable the user to select either to proceed with the transaction or to cancel the transaction by selecting the corresponding button by using a cursor, a mouse, or a touch of a finger.

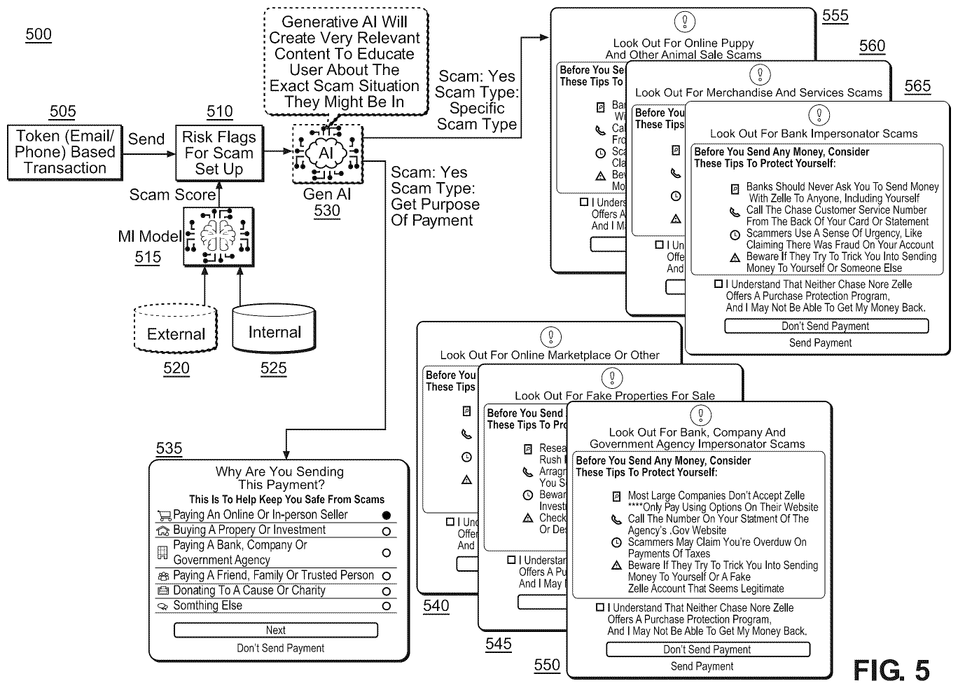

FIG. 5 illustrates a flow diagram 500 for performing real-time fraud detection by using machine learning techniques to proactively identify fraudulent activity before transaction execution is completed, according to an embodiment. As illustrated in FIG. 5, in a first operation 505, a proposed token-based transaction may be initiated by a user, where the token is associated with an email address and/or a telephone number of the user. An ML model 515 may be trained to detect potentially fraudulent activity by using historical transaction-related information from an external source 520 and also historical transaction-related information from an internal source 525.

The ML model 515 may be applied to the proposed token-based transaction, and an output from the ML model 515 may be provided to operation 510, in which risk flags that relate to potentially fraudulent activity, such as a scam, may be generated. The output from the ML model may include a scam score that provides an indication of a likelihood that actual fraudulent activity is associated with the proposed token-based transaction.

A generative AI component 530 may receive an output of operation 510 as an input thereto. The generative AI component 530 may then generate relevant content that is designed to educate the user about a specific type of scam situation and/or fraudulent activity that may appear to be associated with the proposed token-based transaction.

Further, the generative AI component 530 may also generate content that is designed to prompt the user to provide additional information that may assist the user to recognize that there is a relatively high probability that fraudulent activity may be occurring. This content may be provided via a user interface that is displayable on screen of a user device, such as a computer monitor or a mobile smart phone. For example, the user device may display screenshot 535, which may include content that asks the user to provide an explanation as to why the user is proposing to send a payment, and providing several selectable candidate explanations, together with a user prompt to either cancel the proposed transaction or to proceed to the next screen.

When the user proceeds to the next screen, any one or more of screenshot 540, screenshot 545, and/or screenshot 550 may be displayed. Screenshot 540 may include content that warns the user to be aware of online marketplace scams, such as animal sale scams. Screenshot 545 may include content that warns the user to be aware of fake properties for sale and other investment-related scams. Screenshot 550 may include content that warns the user to be on the lookout for scams that entail impersonation of a bank, a company, or a governmental agency.

When the generative AI component 530 generates relevant content that is designed to educate the user about a specific type of scam situation, any one or more of screenshot 555, screenshot 560, and/or screenshot 565 may be displayed. Screenshot 555 may include content that warns the user to be aware of online puppy scams and other animal sale scams. Screenshot 560 may include content that warns the user to be aware of merchandise and services scams. Screenshot 565 may include content that warns the user to be on the lookout for bank impersonator scams.

Accordingly, with this technology, an optimized process for performing real-time fraud detection by using machine learning techniques to proactively identify fraudulent activity before transaction execution is completed is provided.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for performing real-time fraud detection by proactively identifying fraudulent activity before executing a transaction, the method being implemented by at least one processor, the method comprising:
receiving, from a user, first information that relates to a proposed transaction;
providing, as an input to a first machine learning (ML) model, the first information;
using the first ML model to generate a first output that relates to potentially fraudulent activity associated with the first information;
generating, based on the first output, an alert message that includes second information that relates to notifying the user about the potentially fraudulent activity; and
transmitting, to the user, the alert message.

2. The method of claim 1, wherein the first output includes a first score that relates to a likelihood that the first information is associated with actual fraudulent activity, and wherein the score falls in a range of between zero (0) and ten (10).

3. The method of claim 1, further comprising:
providing, as an input to a second ML model that is a large language model (LLM), the first information and the alert message; and
using the second ML model to generate a second output that includes third information that relates to educating the user about the potentially fraudulent activity.

4. The method of claim 3, wherein the third information includes information that relates to at least one from among an online puppy scam, an animal sale scam, a merchandise and services scam, a fake property for sale scam, a fake investment scam, a company impersonator scam, a government agency impersonator scam, and a bank impersonator scam.

5. The method of claim 3, wherein the third information includes information that relates to prompting the user to provide an input relating to a reason for sending a payment in connection with the proposed transaction.

6. The method of claim 5, wherein the third information further includes a plurality of user-selectable candidate explanations for the sending of the payment.

7. The method of claim 3, wherein the third information includes information that relates to prompting the user to provide an input relating to one from among proceeding with sending a payment in connection with the proposed transaction and not proceeding with sending the payment in connection with the proposed transaction.

8. The method of claim 1, wherein the first information includes at least one from among a name of the user, a geographical address of the user, an email address of the user, a telephone number of the user, a proposed date for the proposed transaction, a proposed time of execution for the proposed transaction, an amount of money to be transferred in the proposed transaction, and a recipient of the money to be transferred.

9. The method of claim 1, wherein the first ML model is initially trained by using first historical information that relates to previously executed transactions and second historical information that relates to scams and fraudulent activity.

10. The method of claim 9, further comprising updating a training of the first ML model by using additional information that relates to recently executed transactions that have been executed after the initial training of the ML model is completed.

11. A computing apparatus for performing real-time fraud detection by proactively identifying fraudulent activity before executing a transaction, the computing apparatus comprising:
a processor;
a memory; and
a communication interface coupled to each of the processor and the memory,
wherein the processor is configured to:
receive, from a user via the communication interface, first information that relates to a proposed transaction;
provide, as an input to a first machine learning (ML) model, the first information;
use the first ML model to generate a first output that relates to potentially fraudulent activity associated with the first information;
generate, based on the first output, an alert message that includes second information that relates to notifying the user about the potentially fraudulent activity; and
transmit, to the user via the communication interface, the alert message.

12. The computing apparatus of claim 11, wherein the first output includes a first score that relates to a likelihood that the first information is associated with actual fraudulent activity, and wherein the score falls in a range of between zero (0) and ten (10).

13. The computing apparatus of claim 11, wherein the processor is further configured to:
provide, as an input to a second ML model that is a large language model (LLM), the first information and the alert message; and
use the second ML model to generate a second output that includes third information that relates to educating the user about the potentially fraudulent activity.

14. The computing apparatus of claim 13, wherein the third information includes information that relates to at least one from among an online puppy scam, an animal sale scam, a merchandise and services scam, a fake property for sale scam, a fake investment scam, a company impersonator scam, a government agency impersonator scam, and a bank impersonator scam.

15. The computing apparatus of claim 13, wherein the third information includes information that relates to prompting the user to provide an input relating to a reason for sending a payment in connection with the proposed transaction.

16. The computing apparatus of claim 15, wherein the third information further includes a plurality of user-selectable candidate explanations for the sending of the payment.

17. The computing apparatus of claim 13, wherein the third information includes information that relates to prompting the user to provide an input relating to one from among proceeding with sending a payment in connection with the proposed transaction and not proceeding with sending the payment in connection with the proposed transaction.

18. The computing apparatus of claim 11, wherein the first information includes at least one from among a name of the user, a geographical address of the user, an email address of the user, a telephone number of the user, a proposed date for the proposed transaction, a proposed time of execution for the proposed transaction, an amount of money to be transferred in the proposed transaction, and a recipient of the money to be transferred.

19. A non-transitory computer readable storage medium storing instructions for performing real-time fraud detection by proactively identifying fraudulent activity before executing a transaction, the storage medium comprising executable code which, when executed by a processor, causes the processor to:
receive, from a user, first information that relates to a proposed transaction;
provide, as an input to a first machine learning (ML) model, the first information;
use the first ML model to generate a first output that relates to potentially fraudulent activity associated with the first information;
generate, based on the first output, an alert message that includes second information that relates to notifying the user about the potentially fraudulent activity; and
transmit, to the user, the alert message.

20. The storage medium of claim 19, wherein the first output includes a first score that relates to a likelihood that the first information is associated with actual fraudulent activity, and wherein the score falls in a range of between zero (0) and ten (10).
